(19) United States
(12) Patent Application Publication
(10) Pub. No.: US 2011/0191827 A1
(43) Pub. Date: Aug. 4, 2011

(54) Detecting Unauthorized Router Access Points or Rogue APs in the Wired Network

(76) Inventor: Rajini Balay, Fremont, CA (US)

(21) Appl. No.: 13/016,490

(22) Filed: Jan. 28, 2011

Related U.S. Application Data
(60) Provisional application No. 61/299,841, filed on Jan. 29, 2010.

(51) Int. Cl. G06F 17/30

(52) U.S. Cl. 726/4

(57) ABSTRACT

Detecting rogue access points (APs) or rogue router APs on the wireless network. An authorized access point (AAP) on a network collects wired MAC addresses of wired devices in its subnet, and also collects BSSIDs of wireless devices operating in its vicinity. A rogue is detected by correlating the OUI portion of MAC addresses and BSSIDs after filtering out authorized OUIs.

### CROSS-REFERENCES TO RELATED APPLICATIONS

This application claims the benefit of priority on U.S. Provisional Patent Application No. 61/299841 filed Jan. 29, 2010 and entitled “Detecting Unauthorized Router Access Points or Rogue APs in the Wired Network” (Attorney Docket No. 06259P082Z).

### BACKGROUND OF THE INVENTION

The present invention relates to digital networks, and in particular, to the problem of detecting unauthorized devices such as access points attached to a wired network.

Wired and wireless digital networks are becoming necessities of business as much as electricity. Yet for all the capabilities such networks enable for an organization, small or large, such networks if not secured open an organization to risk. Unauthorized access to a network and to devices attached to the network may place at risk not only the valuable resources and information of the organization, but also may place at risk client information. In a financial institution, this could be client finances. In a health care institution, this could be medical records. In a retail establishment, this could be customer credit card information. Networks need to be secured, with only authorized equipment attached to the network.

For networks with wireless capability, it is important that only authorized access points (APs) are present on the network, authorized APs the organization knows about and manages, keeping appropriate access policies in place and only permitting secure access to authorized wireless clients.

Yet the flexibility of modern networks, as well as their ubiquity, allows their security to be breached. As an example, a user may connect a consumer-grade AP to a corporate network to make their own job easier, unknowingly exposing the organization to risk. Or an unauthorized AP may be connected to the network by someone with less than honorable intentions, to provide surreptitious access.

An unauthorized or rogue access point (AP) is an AP that does not belong to the wireless infrastructure of an organization, and one that is connected to the wired network without permission. Current rogue AP detection algorithms look for correlation between devices seen on the wired side of the network to devices seen on the wireless side. Such mechanisms work for an AP which is only doing bridging. In the case of a router AP or a layer-3 (ISO L3) AP, MAC addresses on the wired side are not visible to the network when communicating through the AP. As a result, it is not easy to detect a router AP as a rogue.

What is needed is a way of detecting rogue APs and unauthorized router APs on the wired network.

### BRIEF DESCRIPTION OF THE DRAWINGS

The invention may be best understood by referring to the following description and accompanying drawings that are used to illustrate embodiments of the invention in which:

FIG. 1 shows a wireless network.

### DETAILED DESCRIPTION

Embodiments of the invention relate to methods of activating an access point in a wireless network. According to the invention, an authorized access point (AAP) has a presence on both wired and wireless networks. The AAP can detect APs in its wireless neighborhood, monitoring wireless channels and accumulating a list of MAC addresses and BSSIDs for wireless APs. Similarly, the AAP can learn the MAC addresses of wired devices on its subnet. The MAC address of a device, as specified by the IEEE, comprises a manufacturer's identifier known as the OUI (Organizationally Unique Identifier) combined with status flags and a sequence number. Rogue devices are discovered by correlating MAC address OUIs in the wired and wireless domains and filtering against a list of authorized OUIs.

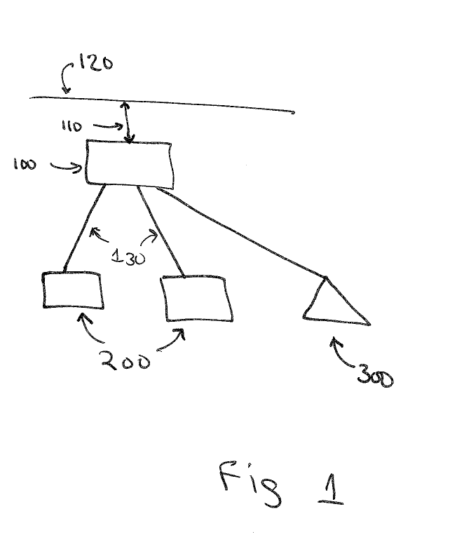

FIG. 1 shows a wireless network in which controller 100 communicates 110 to a wired network 120 such as the Internet. Controller 100 also communicates 130 with authorized access points 200, which in turn provide wireless services to wireless client devices. Also present is rogue access point 300.

As is known to the art, controller 100 and access points 200, 300 are purpose-built digital devices, each having a processor, memory hierarchy, and a plurality of input/output interfaces. In one embodiment of the invention, a MIPS-class processor such as those from Cavium or RMI is used. Other suitable processors, such as those from Intel or AMD may also be used. The memory hierarchy usually comprises fast read/write memory for holding processor data and instructions while operating, and nonvolatile memory such as EEPROM and/or Flash for storing files and system startup information. Wired interfaces are typically IEEE802.3 Ethernet interfaces. Wireless interfaces may be WiMAX, 3G, 4G, and/or IEEE802.11 wireless interfaces. In one embodiment of the invention, controller 100 and access points 200 operate under control of a LINUX operating system, with purpose-built programs providing host controller and access point functionality. While FIG. 1 shows controller 100 separate from access points 200, a controller may also have access point capabilities built in, providing both wired and wireless connectivity. Similarly, controller functionality may be spread over one or more APs 200.

According to the invention, an authorized access point (AAP) on the network searches for rogue (unauthorized) devices by collecting and accumulating MAC addresses visible to its wired and also to its wireless interfaces.

As known to the art, and as defined in IEEE specifications, a MAC address is comprised of an organizational unique identifier portion (OUI), status bits, and a sequence portion. The OUI allows manufacturers to identify devices they manufacture, and to be able to give each device a unique MAC address. For 48-bit MAC addresses, the first three bytes (24 bits) contain the OUI and two status bits. The lower 24 bits (three bytes) of the MAC address are device specific, commonly a sequence identifier. OUIs are managed by the IEEE Registration Authority and are defined in ANSI/IEEE standard 802-2001.

The out of box configuration for an off the shelf router AP is such that the wired Ethernet MAC address is offset by 1 from the wireless BSSID of the AP. If the AP can support multiple BSSIDs, then the BSSID addresses follow a sequential order. If a rogue AP 300 has such a default configuration, it is detectable according to the invention using a correlation function of +/−1 between a MAC address that is seen on the wired side to that of the BSSID of the AP. In many devices the MAC address of a router AP can be changed by the user. If the user changes the Ethernet MAC or the BSSID to be something that is not offset by 1, this simple technique would not be able to detect the rogue AP.

One way to identify such unauthorized APs is to identify APs that belong to a certain manufacturer, and flag them for user inspection. However, this approach has a lot of overhead, because the check requires an updated list of Access Point manufacturers. While the OUI list is readily available from the IEEE, it changes frequently.

The present invention detects an AP as a rogue as long as the Ethernet MAC and the BSSID retain the OUI. This mechanism does not depend on the offset between the Ethernet MAC and the BSSID of the AP. It also does not depend on maintaining a copy of the list of IEEE OUIs for Access Point manufacturers.

The mechanism according to the invention identifies both a BSSID seen on the wireless interface as a rogue, and a MAC address that is seen on the wired interface as a rogue.

An authorized access point (AAP) which is on the same subnet as the router AP will be able to learn the MAC addresses of the wired devices on its subnet. By monitoring on the air through its IEEE802.11 wireless interface, the AAP will be able to see other wireless devices and record their BSSIDs. The AAP may scan one or multiple channels on one or more bands, such as the 2.4 and 5 GHz IEEE 802.11 Wi-Fi bands.

As an example, assume there is an unauthorized router AP 300 whose wired Ethernet MAC address is MAC1, and whose wireless BSSID is MAC2 attached to the network. An AAP 200 which is on the same subnet as router AP 300 will be able to see MAC1 on its wired interface, and MAC2 on its wireless interface. AAP 200 compares OUIs extracted from MAC1 and MAC2 to a list of authorized OIUs.

This list may be provided by controller 100, or may be preloaded into AAP 200. As an example, such a list may be prepopulated with the OUIs used by the manufacturer of AAP 200 and controller 100. This list may also be updated, on demand, then the list contents change, or on command of a system administrator. In some embodiments, OUIs on an authorized list may be marked as wired, wireless, or both; an alternative would be to provide separate wired and wireless lists of authorized OUIs.

Assume that the OUIs extracted from MAC1 and MAC2 do not match any OUls on the authorized OUI list.

According to the invention, because MAC1 and MAC2 are using the same OUI:

MAC1 is a rogue because it is plugged onto the wired side,

MAC2 is a potential wireless device and is a rogue because it has the same OUI as a wireless device.

This process also provides the ability to identify router APs as rogues without relying on an OUI list of AP manufacturers, or a specific offset between the Ethernet MAC and BSSID.

The OUIs from wireless APs are learned dynamically from the APs that are seen in the RF neighborhood.

Optionally, potential false positives can be alleviated by screening out OUIs for authorized APs on the network.

As described, determining the presence of a rogue is made in an AAP using information gathered only by that AAP. Optionally, the AAP may include information gathered from other AAPs in the network.

In another embodiment of the invention, this determination may be made by another device attached to the network, such as controller 100, receiving BSSID information collected from authorized APs, and collecting MAC addresses for connected wired devices.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following:

a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

I claim:

1. A method of detecting rogue access points attached to a wired network comprising:
collecting, at an authorized device on the network, MAC addresses of other devices on the wired network,
collecting, at the authorized device on the network, BSSIDs of wireless devices which can be received by the authorized device,
extracting OUIs from the collected MAC addresses and BSSIDs, filtering the extracted OUIs against a list of authorized OUIs for the network, and flagging as potential rogues those OUIs not on the list of authorized OUIs.

2. The method of claim 1 further including the step of flagging as potential rogues the MAC addresses for those OUIs not on the list of authorized OUIs.

3. The method of claim 1 where the step of flagging as potential rogues those OUIs not on the list of authorized OUIs only flags an OUI as a potential rogue if the OUI is not on the list of authorized OUIs and the OUI appears on both wired and wireless collections.

4. The method of claim 1 where the steps of collecting, extracting, filtering, and flagging are performed on an authorized access point on the network.

5. The method of claim 1 where the step of flagging as potential rogues those OUIs not on the list of authorized OUIs is performed on a different authorized device on the network than the step of collecting BSSIDs of wireless devices.

6. The method of claim 5 where the device performing the step of flagging as potential rogues those OUIs not on the list of authorized OUIs is a controller.

7. A machine readable medium having a set of instructions stored in nonvolatile form therein, which when executed on one or more devices attached to a digital network causes a set of operations to be performed comprising:
collecting, at an authorized device on the network, MAC addresses of other devices on the wired network,
collecting, at the authorized device on the network, BSSIDs of wireless devices which can be received by the authorized device,
extracting OUIs from the collected MAC addresses and BSSIDs, filtering the extracted OUIs against a list of authorized OUIs for the network, and flagging as potential rogues those OUIs not on the list of authorized OUIs.
